(19) United States
(12) Patent Application Publication
(10) Pub. No.: US 2020/0004545 A1
(43) Pub. Date: Jan. 2, 2020

(54) INFORMATION PROCESSING DEVICE AND NON-TRANSITORY COMPUTER READABLE MEDIUM

(71) Applicant: FUJI XEROX CO., LTD., Tokyo (JP)

(72) Inventor: Atsushi MONNA, Kanagawa (JP)

(73) Assignee: FUJI XEROX CO., LTD., Tokyo (JP)

(21) Appl. No.: 16/442,567

(22) Filed: Jun. 17, 2019

(30) Foreign Application Priority Data
Jun. 27, 2018 (JP) 2018-122323

(51) Int. Cl. G06F 9/38

(52) U.S. Cl. CPC G06F 9/3836

(57) ABSTRACT

An information processing device includes a generation unit and a providing unit. The generation unit generates data corresponding to a process specified by a user. The providing provides, after generation of the data, identification information to be used by the user to issue an instruction for a post-process for the data generated by the generation unit.

### CROSS-REFERENCE TO RELATED APPLICATIONS

This application is based on and claims priority under 35 USC 119 from Japanese Patent Application No. 2018-122323 filed Jun. 27, 2018.

### BACKGROUND

### (i) Technical Field

The present disclosure relates to an information processing device and a non-transitory computer readable medium.

### (ii) Related Art

In Japanese Unexamined Patent Application Publication No. 2013-90338, a cloud processing method including an identification mechanism applied to processing for a document, the cloud processing method including setting at least one corresponding processing procedure to the document; acquiring identification information of the at least one corresponding processing procedure; acquiring a front cover including the identification information; scanning the front cover and the document and acquiring the identification information to generate data of the scanned document; and processing the document in accordance with the at least one corresponding processing procedure, based on the identification information of the front cover, is disclosed.

In Japanese Unexamined Patent Application Publication No. 2014-238786, an information system communicating with multiple cloud servers, the information system including an information management unit that manages account information indicating an account allocated to a user of the information system for each of the multiple cloud servers; an acquisition unit that accesses, when the user logs in, each of the multiple cloud servers using the account information and acquires use information indicating a state of use by the user from the cloud server; and a user interface unit that causes the states of use of the multiple cloud servers for the user indicated by the use information to be displayed as a list on a display provided on a device operated by the user when logging in, is disclosed.

In Japanese Unexamined Patent Application Publication No. 2015-55951, an information processing system including one or more computers, the information processing system including a reception unit that receives image data from a device; a processing unit that performs processing for the image data; a generation unit that generates first bibliography information regarding the image data or the processing; and a transmission unit that transmits the first bibliography information to a transmission destination of the image data or data generated as a result of the processing, is disclosed.

In recent years, information processing devices including a scan function for reading contents of an original to generate data of the original and an image forming function for forming an image captured with a camera or the like on a recording medium such as paper have been installed in more stores.

In the case where a user uses an information processing device in a store, during a period from a user's operation for causing the information processing device to execute a desired function until completion of the processing, the user might need to wait in front of the information processing device, without performing any particular operation, until the processing is completed. In a situation in which other people who wish to use the information processing device wait in line following the user, if the user needs to wait in front of the information processing device for a long time without performing any operation for the information processing device, the user might feel hesitate in front of the other people who are waiting in the line.

### SUMMARY

Aspects of non-limiting embodiments of the present disclosure relate to provide an information processing device and a non-transitory computer readable medium that are capable of allowing a user who has issued an instruction to start a process to avoid waiting until a series of processes has been completed at a place where an information processing device for which the instruction to start the process has been issued is installed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including a generation unit and a providing unit. The generation unit generates data corresponding to a process specified by a user. The providing provides, after generation of the data, identification information to be used by the user to issue an instruction for a post-process for the data generated by the generation unit.

### BRIEF DESCRIPTION OF THE DRAWINGS

Exemplary embodiments of the present disclosure will be described in detail based on the following figures, wherein:

FIG. 1 is a diagram illustrating an example of a configuration of an information processing system;

FIG. 2 is a diagram illustrating an example of a configuration of a principal part of an electrical system in the information processing device;

FIG. 3 is a flowchart illustrating an example of the flow of an information process performed by the information processing device;

FIG. 4 is a sequence diagram illustrating an example of the flow of information in the information processing system;

FIG. 5 is a flowchart illustrating an example of the flow of a post-process performed by an external device; and

FIG. 6 is a flowchart illustrating an example of the flow of a storing process performed by a storage device.

### DETAILED DESCRIPTION

Exemplary embodiments of the present disclosure will be described below with reference to drawings. Components and processes having the same functions will be referred to with the same reference signs throughout all the drawings and redundant explanations will be omitted.

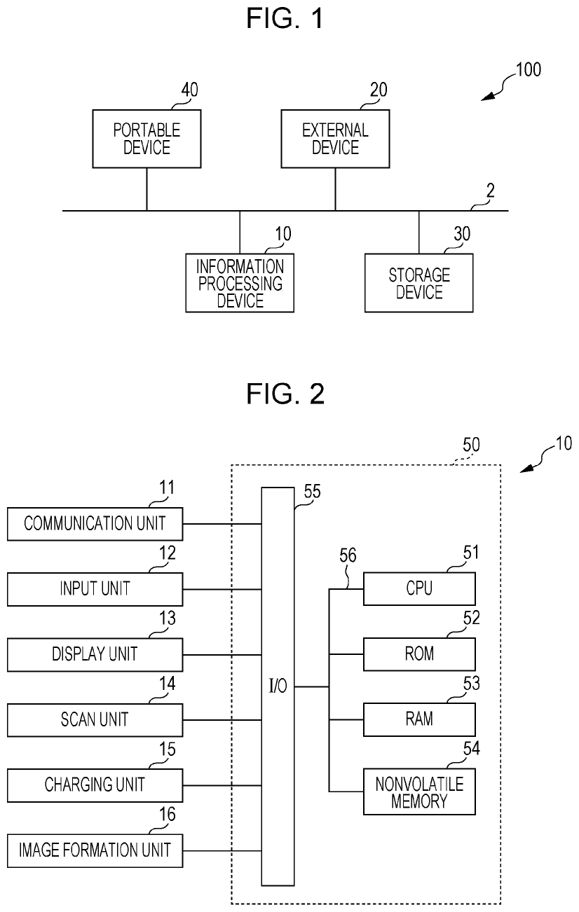

FIG. 1 is a diagram illustrating an example of a configuration of an information processing system 100 according to an exemplary embodiment. As illustrated in FIG. 1, the information processing system 100 includes an information processing device 10, an external device 20, a storage device 30, and a portable device 40. The information processing device 10, the external device 20, the storage device 30, and the portable device 40 are connected to one another by a communication line 2.

The information processing device 10 is installed in a store, such as a convenience store, open to the general public.

The information processing device 10 includes functions for providing various services to users for a fee or free of charge. For example, the information processing device 10 includes a ticketing function, a scan function for optically reading contents of an original placed on a platen glass, a print function for forming an image captured with a camera onto a recording medium such as paper, and the like.

Now, as an example, a case where a user uses a service for executing a scan function of the information processing device 10 will be described. The service for executing the scan function (scan service) represents a service for decorating a scanned image of an original generated using the scan function, for example, by changing sentences, changing a layout, such as rotation or inversion, adding a frame, a diagram such as a heart shape, an animal character image, and the like.

Such a scan service may be divided into a “pre-process” for causing a scan unit 14 to read an original in accordance with an instruction from a user and generating a scan image and a “post-process” for performing processing specified by the user for the scanned image generated by the pre-process. In the above example, changing contents of the scanned image, changing the layout, decorating the scanned image, and the like correspond to the post-process.

The information processing device 10 performs the pre-process to generate a scanned image. However, taking into consideration the processing capability of the information processing device 10 and the like, the information processing device 10 may not perform the subsequent post-process but may request the external device 20 to perform the subsequent post-process. Therefore, when finishing the pre-process, the information processing device 10 provides identification information to a user and then transmits the generated scanned image to the external device 20. The “identification information” includes information for identifying the external device 20 that is to perform the post-process, for example, a uniform resource locator (URL) of the external device 20, and authentication information, such as an ID and a password, used for authentication processing performed for connection with the external device 20 represented by the URL.

Hereinafter, data including some kind of information such as a scanned image to be notified to a person will be referred to as a “document”. Documents include characters, diagrams, signs, images, video, sound, information on arrangement of characters, images, and the like, and attributes representing characteristics of a document. Attributes representing the characteristics of a document are, for example, information to be used to manage the document, such as a file name for identifying the document, a creator who created the document, the date and time when the document was created, and the like. That is, a document is an example of data generated in accordance with a process specified by a user.

The external device 20 is a device that performs the post-process. When receiving a document from the information processing device 10, the external device 20 performs a process specified for the document. No restriction is placed on contents of the post-process performed by the external device 20. The external device 20 performs a post-process corresponding to a service that the information processing device 10 provides to a user.

The external device 20 transfers the document for which the post-process has been performed (hereinafter, may be referred to as a “processed document”) to the storage device 30, in accordance with an instruction from a user who has established connection with the external device 20, based on the identification information provided by the information processing device 10.

When receiving the processed document from the external device 20, the storage device 30 stores the processed document into a memory. The user connects the portable device 40 that the user is operating to the storage device 30 to acquire the processed document stored in the storage device 30.

The portable device 40 is an electronic device that is connected to the information processing device 10, the external device 20, and the storage device 30 to transmit and receive information to and from them.

To use the scan service of the information processing device 10, a user sets an electronic device for receiving identification information in the information processing device 10. Any type of electronic device may be set as a device for receiving identification information as long as it includes a communication function for establishing connection with the communication line 2, a display function for displaying the identification information received from the information processing device 10, an input function for receiving an instruction from a user, and a processing function for performing a process in accordance with the received instruction. In this exemplary embodiment, for example, the portable device 40 such as a tablet device, a smartphone, a wearable device, or the like, which is a device assumed to be carried by a user, is set as an electronic device for receiving identification information. The portable device 40 may be owned by or leased to a user.

The portable device 40 that has received identification information is connected to the external device 20 using the identification information, and notifies the external device 20 of an instruction from a user that, for example, “Transfer a processed document to the storage device 30”.

The portable device 40 is also connected to the storage device 30 to acquire the processed document transferred to the storage device 30.

Regarding the information processing device 10, the external device 20, the storage device 30, and the portable device 40 included in the information processing system 100, there is no limitation imposed on the number of the information processing devices 10, the number of the external devices 20, the number of the storage devices 30, and the number of the portable devices 40. For example, in the case where there are multiple external devices 20, the information processing device 10 transmits a document to an external device 20 that is to perform a post-process corresponding to contents of a service specified by a user, and transmits identification information of the external device 20 to which the document is transmitted to a portable device 40 specified by the user. Furthermore, in the case where there are multiple storage devices 30, for example, a user may notify, using the portable device 40 that has received the identification information, the external device 20 of a storage device 30 to which a processed document is to be transferred.

In an exemplary embodiment, an example in which the information processing system 100 is installed in a store is described. However, the information processing device 10 may be installed in any place. For example, the information processing device 10 may be installed on a floor of a company or the like only specific people are allowed to come and go through. In this case, a function of the information processing device 10 may be provided to employees of the company for free of charge.

Furthermore, the communication line 2 may be a wireless line or a wired line and may be a dedicated line or a public line to which an unspecified number of devices are connected. However, since the portable device 40 moves along with a user, it is preferable that the communication line 2 that allows connection between the portable device 40, the information processing device 10, the external device 20, and the storage device 30 is a wireless line.

Next, an example of a configuration of a principal part of an electrical system of the information processing device 10 will be described with reference to FIG. 2.

As illustrated in FIG. 2, the information processing device 10 includes, for example, a computer 50.

The computer 50 includes a central processing unit (CPU) 51 that takes on the functions of a generation unit that generates a document, a providing unit that provides identification information, and a transmission unit that transmits a processed document to the external device 20, a read only memory (ROM) 52 that stores a program executed by the CPU 51, a random access memory (RAM) 53 that is used as a temporary operation region for the CPU 51, a nonvolatile memory 54, and an input/output interface (I/O) 55. The CPU 51, the ROM 52, the RAM 53, the nonvolatile memory 54, and the I/O 55 are connected to one another via a bus 56.

The nonvolatile memory 54 is an example of a memory in which stored data is maintained even when electric power supplied to the nonvolatile memory 54 is interrupted. For example, the nonvolatile memory 54 is a semiconductor memory. However, a hard disk may be used as the nonvolatile memory 54.

In contrast, for example, a communication unit 11, an input unit 12, a display unit 13, a scan unit 14, a charging unit 15, and an image formation unit 16 are connected to the I/O 55.

The communication unit 11 is connected to the communication line 2. The communication unit 11 includes a communication protocol for transmitting and receiving various data to and from devices included in the information processing system 100.

The input unit 12 is an input device that notifies the CPU 51 of an instruction received in accordance with an operation performed by a user. The input unit 12 includes, for example, a button, a touch panel, a keyboard, a mouse, and the like.

The display unit 13 is a display that displays information processed as an image by the CPU 51. The display unit 13 may be, for example, a liquid crystal display, an organic electroluminescence display, or the like.

The scan unit 14 optically reads contents of an original placed on a platen glass, and a document generated by the reading is stored into the RAM 53.

The charging unit 15 is a device that collects a fee for a fee-based service provided by the information processing device 10 and notifies the CPU 51 that payment has been performed. The charging unit 15 handles, for example, payment by at least one of electronic money, a credit card, cash, and a prepaid card.

The image formation unit 16 issues information regarding a service executed by a user, such as a receipt noting the amount of money paid by the user.

The scan unit 14, the charging unit 15, and the image formation unit 16 are not necessarily connected to the I/O 55. Furthermore, units connected to the I/O 55 are not necessarily those illustrated in the example of FIG. 2. For example, to receive a document stored in a universal serial bus (USB) memory or a semiconductor memory such as a memory card, an interface unit including a USB interface and a card reader may be connected to the I/O 55.

As with the information processing device 10, the external device 20 and the storage device 30 each include the computer 50. However, the computer 50 configuring each of the external device 20 and the storage device 30 does not need to include the scan unit 14 and the charging unit 15.

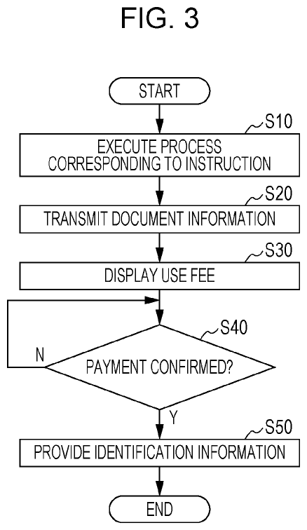

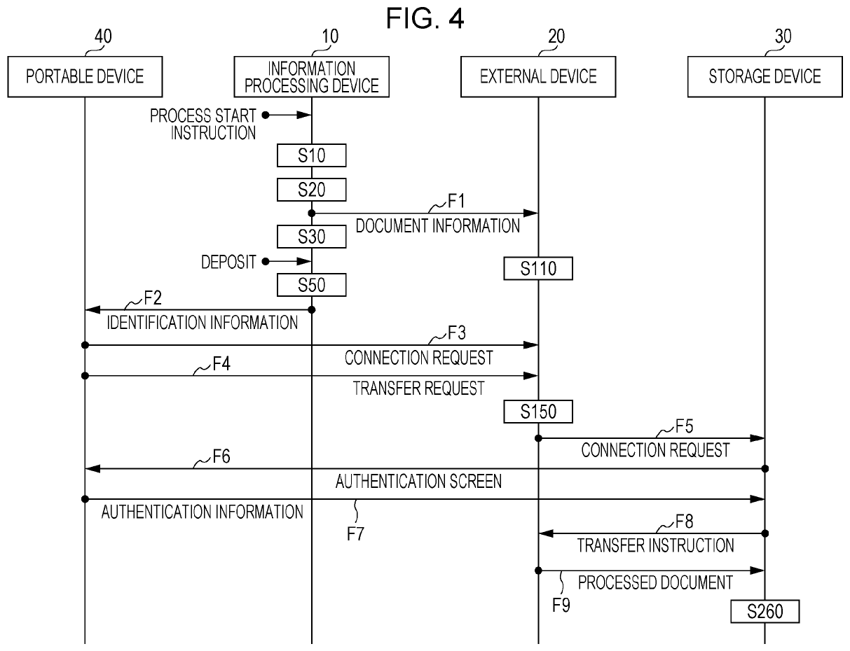

Next, a process performed by the information processing device 10 will be described in detail with reference o FIGS. 3 and 4.

FIG. 3 is a flowchart illustrating an example of the flow of an information process performed by the CPU 51 of the information processing device 10 in the case where a user of a fee-based service provided by the information processing device 10 instructs the information processing device 10 to start a desired service. As described above, as an example, the flow of an information process performed when a user issues an instruction to start a scan service will be described.

FIG. 4 is a sequence diagram illustrating an example of the flow of information in the information processing device 10, the external device 20, the storage device 30, and the portable device 40 in the case where a scan service is executed.

An information processing program that prescribes an information process is stored in advance in, for example, the ROM 52 of the information processing device 10. The CPU 51 of the information processing device 10 reads the information processing program stored in the ROM 52 and executes the information process.

In step S10, the CPU 51 executes a process specified by a user. When the user issues an instruction to execute a scan service, the CPU 51 controls the scan unit 14 to read contents of an original and generate a document corresponding to the original. When the user issues an instruction to execute a print service, the CPU 51 acquires a photographed imaged captured with, for example, a smartphone, via an interface unit, which is not illustrated in FIG. 2.

When a pre-process for the process specified by the user in step S10 is finished, in order to request the external device 20 for the subsequent post-process, the CPU 51 transmits document information including the document generated in step S10 to the external device 20 in step S20 (FIG. 4: F1). In the case where there are external devices 20 corresponding to individual services, the CPU 51 transmits document information to an external device 20 corresponding to a service for which a user has issued an execution instruction.

The document information includes, for example, a processing parameter to be used in the post-process and authentication information, as well as the document generated in step S10. For example, in the case where processing for rotating a document is performed in the post-process, a rotation angle is set as a processing parameter. The processing parameter is set by, for example, a user. Regarding the authentication information, a value set at random by the information processing device 10, for example, for each transmission operation of document information, is set.

In step S30, the CPU 51 displays a fee for the service used by the user (in this case, the scan service) on the display unit 13. Based on this display, the user pays the fee for the service used.

Therefore, in step S40, the CPU 51 determines, based on notification from the charging unit 15, whether or not the fee displayed in step S30 has been paid. In the case where the fee has not been paid, the CPU 51 repeatedly performs the determination processing in step S40 and monitors the fee payment status. In contrast, in the case where the fee has been paid, the process proceeds to step S50.

In step S50, the CPU 51 provides identification information to the portable device 40 specified by the user (FIG. 4: F2). The identification information includes the URL of the external device 20 to which the document information has been transmitted and the authentication information included in the transmitted document information.

For transmission of the identification information to the portable device 40, for example, Wi-Fi® or Bluetooth® is used. The user may specify the portable device 40 to which the identification information is to be provided, during an operation at the information processing device 10 for issuing an instruction to execute a service, or may specify the portable device 40 in advance, from the portable device 40 via the communication line 2, prior to use of the information processing device 10.

When the identification information is provided to the user, an instruction for the subsequent post-process is able to be performed using the portable device 40. Therefore, even if the process regarding the service for which an execution instruction has been issued is not completed, the user is able to move away from the place where the information processing device 10 is installed, without waiting until completion of the process. That is, once the pre-process that has to be performed at the place where the information processing device 10 is installed, such as a button operation on the information processing device 10, insertion and removal of a semiconductor memory into and from the interface unit, which is not illustrated in FIG. 2, and collection of an original placed at the scan unit 14, is finished.

In the case where a service provided by the information processing device 10 is free of charge, after transmitting the document information to the external device 20 in step S20, the information processing device 10 may provide the identification information to the portable device 40 that is specified by the user.

The information process illustrated in FIG. 3 is completed as described above.

Subsequently, at any place and any time desired, the user connects the portable device 40 with the external device 20 using the identification information transmitted to the portable device 40 (FIG. 4: F3), so that the user may issue an instruction to perform the post-process to the external device 20, using the portable device 40. In this case, the portable device 40 adds the authentication information included in the identification information to a connection request to the external device 20 to indicate that the connection request is an authenticated connection request.

In the case where the URL of the external device 20 included in the identification information is represented by a link format in which pressing the URL establishes connection with the external device 20, for connection of the portable device 40 to the external device 20, a labor of the user to input the URL of the external device 20 one by one to the portable device 40 is able to be omitted. Therefore, it is preferable that the information processing device 10 transmits the URL of the external device 20 represented by a link format to the portable device 40.

Furthermore, in the case where a user does not carry a usable portable device 40, the user may specify, instead of the portable device 40, the information processing device 10 for which the user has issued an instruction to execute a service as a device that is to receive identification information. In this case, the information processing device 10 causes the image formation unit 16 to issue a receipt noting the identification information. The identification information noted on the receipt is represented by a barcode format such as a two-dimensional barcode. Therefore, the user is able to connect the information processing device 10 to the external device 20 that is to perform the post-process only by causing a barcode reader, which is not illustrated in FIG. 2, provided at the information processing device 10, to read the receipt, not by understanding contents of the identification information and pressing a button or the like to input the identification information to the information processing device 10.

Furthermore, even in the case where the user carries the portable device 40, the user may specify the information processing device 10 as a device that is to receive the identification information. In this case, an image of a barcode on the receipt issued by the information processing device 10 is captured with a camera of the portable device 40, so that the portable device 40 may be connected to the external device 20.

A barcode reader and a camera for reading identification information from the reception intensity of light reflected to light applied to the receipt are an example of an optical sensor according to an exemplary embodiment.

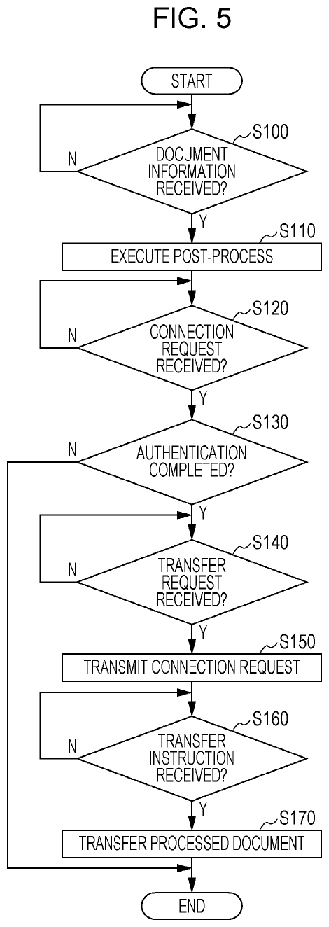

FIG. 5 is a flowchart illustrating an example of the flow of the post-process performed by the CPU 51 of the external device 20 after the external device 20 is activated.

The information processing program for execution of the post-process is stored in advance, for example, in the ROM 52 of the external device 20. The CPU 51 of the external device 20 reads the information processing program stored in the ROM 52 to execute the post-process. The “CPU 51” in the explanation for the flowchart illustrated in FIG. 5 represents the CPU 51 of the external device 20.

First, in step S100, the CPU 51 determines whether or not document information (FIG. 4: F1) has been received from the information processing device 10. In the case where document information has not been received, the CPU 51 repeatedly performs the determination processing in step S100 and monitors the reception status of document information. In contrast, in the case where document information has been received, the process proceeds to step S110.

In step S110, the CPU 51 executes the post-process in accordance with contents of a processing parameter included in the document information received in step S100, and generates a processed document.

In step S120, the CPU 51 determines whether or not a connection request (FIG. 4: F3) has been received from the portable device 40. In the case where a connection request has not been received, the CPU 51 repeatedly performs the determination processing in step S120 and monitors the reception status of a connection request. In contrast, in the case where a connection request has been received, the process proceeds to step S130.

To reduce unauthorized connection to the external device 20, the CPU 51 performs authentication processing for determining whether or not the connection request received in step S120 is an authorized connection request from the user who uses the service at the information processing device 10. Specifically, authentication information included in the identification information provided by the information processing device 10 that has performed the pre-process is added to the connection request received in step S120. Therefore, in step S130, the CPU 51 determines whether or not the authentication information added to the connection request is the same as the authentication information included in the document information received in step S100.

In the case where the authentication information added to the connection request is not authorized authentication information, the connection request is considered to be unauthorized connection, which represents that connection with the external device 20 is not permitted. Therefore, the post-process illustrated in FIG. 5 is terminated, without establishing connection with the portable device 40. In contrast, in the case where the authentication information added to the connection request is prescribed authentication information, connection with the portable device 40 from which the connection request has been transmitted is established, and the process proceeds to step S140.

In step S140, the CPU 51 determines whether or not a transfer request (FIG. 4: F4) for a processed document, which is an example of an instruction to the post-process, has been received from the portable device 40. As a method for acquiring a processed document from the external device 20, for example, a user causes the external device 20 to transfer the processed document to a device specified by the user, and acquires the processed document from the device to which the processed document has been transferred. Here, for example, the storage device 30 is specified as a transfer destination of a processed document, by a transfer request. However, for example, the information processing device 10 or the portable device 40 may be specified as a transfer destination of a processed document.

In the case where a transfer request has not been received, the CPU 51 repeatedly performs the determination processing in step S140 and monitors the reception status of a transfer request. In contrast, in the case where a transfer request has been received, the process proceeds to step S150.

In step S150, in order to transfer the processed document tot eh storage device 30, which is a transfer destination specified by the transfer request received in step S140, the CPU 51 first transmits a connection request to the storage device 30 (FIG. 4: F5). An identifier (for example, an IP address) for uniquely identifying an instruction device (the information processing device 10 or the portable device 40) that has issued an instruction for the post-process to be performed at the external device 20 is added to the connection request.

In step S160, the CPU 51 determines whether or not a transfer instruction (FIG. 4: F8) for permitting transfer of the processed document has been received from the storage device 30. In the case where a transfer instruction has not been received, the CPU 51 repeatedly performs the determination processing in step S160 and monitors the reception status of a transfer instruction. In contrast, in the case where a transfer instruction has been received, the process proceeds to step S170.

In step S170, the CPU 51 transfers the processed document to the storage device 30 (FIG. 4: F9), and ends the post-process illustrated in FIG. 5.

In the post-process illustrated in FIG. 5, a transfer request for a processed document is received as an example of an instruction for the post-process. However, a processing parameter may be received prior to execution of the processing in step S110. In this case, an operation of a user at the information processing device 10 for setting a processing parameter is omitted. Therefore, compared to the case where a user sets a processing parameter at the information processing device 10, the time during which the information processing device 10 is occupied is shortened.

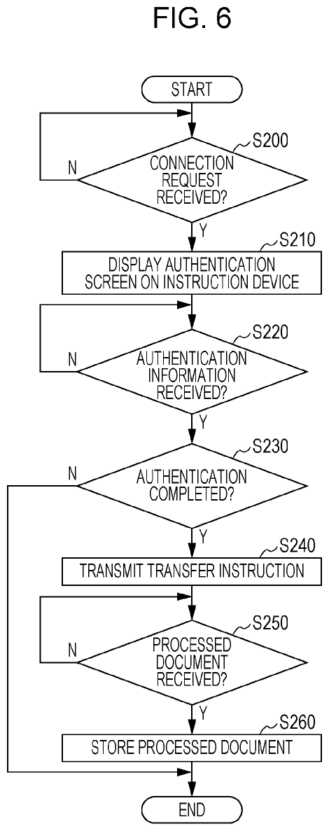

FIG. 6 is a flowchart illustrating an example of the flow of a storing process executed by the CPU 51 of the storage device 30 after the storage device 30 is activated.

The information processing program for execution of the storing process is stored in advance, for example, in the ROM 52 of the storage device 30. The CPU 51 of the storage device 30 reads the information processing program stored in the ROM 52 and executes the storing process. The “CPU 51” in the explanation for the flowchart illustrated in FIG. 6 represents the CPU 51 of the storage device 30.

First, in step S200, the CPU 51 determines whether or not a connection request (FIG. 4: F5) has been received from the external device 20. In the case where a connection request has not been received, the CPU 51 repeatedly performs the determination processing in step S200 and monitors the reception status of a connection request. In contrast, in the case where a connection request has been received, the process proceeds to step S210.

In step S210, the CPU 51 refers to an identifier added to the connection request received in step S200, and transmits display data for displaying an authentication screen to an indication device that has issued an instruction for the post-process to the external device 20 (FIG. 4: F6). The authentication screen is a screen that allows the user to input authentication information required for connection with the storage device 30, and the input authentication information is transmitted to the storage device 30. Subsequently, in order to distinguish the authentication information from authentication information to be used for connection with the external device 20, the authentication information to be used for connection with the storage device 30 will be referred to as “transfer authentication information”.

In step S220, the CPU 51 determines whether or not transfer authentication information (FIG. 4: F7) has been received from the instruction device (in this case, the portable device 40). In the case where transfer authentication information has not been received, the CPU 51 repeatedly performs the determination processing in step S220 and monitors the reception status of transfer authentication information. In contrast, in the case where transfer authentication information has been received, the process proceeds to step S230.

In step S230, the CPU 51 compares the transfer authentication information that is set in advance by the user for the storage device 30 with the transfer authentication information received in step S220 to determine whether or not the two pieces of transfer authentication information are the same. The transfer authentication information that is set in advance by the user for the storage device 30 is, for example, stored in advance in the nonvolatile memory 54.

In the case where the two pieces of transfer authentication information are different, the connection request received in step S200 is considered to be unauthorized connection, which represents that connection with the storage device 30 is not permitted. Therefore, the storing process illustrated in FIG. 6 is terminated, without establishing connection with the instruction device from which the connection request has been transmitted. In contrast, in the case where the two pieces of transfer authentication information are the same, the connection request received in step S200 is considered to be an authorized connection request from the user. Therefore, the process proceeds to step S240.

In step S240, the CPU 51 transmits a transfer instruction for transfer of the processed document to the external device 20 that has received the connection request (FIG. 4: F8).

In step S250, the CPU 51 determines whether or not the processed document (FIG. 4: F9) has been received from the external device 20 that has received the connection request. In the case where the processed document has not been received, the CPU 51 repeatedly performs the determination processing in step S250 and monitors the status of transfer of the processed document. In contrast, in the case where the processed document has been received, the process proceeds to step S260.

In step S260, the CPU 51 stores the processed document received in step S250 into, for example, the nonvolatile memory 54. For example, the user causes the instruction device to read the processed document stored in the storage device 30, and acquires the final result of the service executed at the information processing device 10.

In the storing process illustrated in FIG. 6, transfer authentication information is received from an instruction device. However, by the time when the user moves away from in front of the information processing device 10 after the pre-process is finished, specifically, for example, by the time when document information is transmitted to the external device 20, the information processing device 10 may receive input of transfer authentication information. The information processing device 10 that has received the transfer authentication information transmits document information including the received transfer authentication information to the external device 20. If the external device 20 causes the connection request, which is to be transmitted to the storage device 30, to include the transfer authentication information received from the information processing device 10, the processing of step S210 and S220 is unnecessary.

The storing process illustrated in FIG. 6 is finished as described above.

As described above, in the information processing system 100, when the pre-process for the service for which an execution instruction is issued by a user is finished, the information processing device 10 provides identification information to a device specified by the user. In the case where the device specified by the user is the portable device 40, the user is able to issue an instruction for the post-process at a place away from the place where the information processing device 10 is installed.

As described above, in the instruction for the post-process that is to be performed subsequently to the post-process may include transfer authentication information to be used to transfer of a processed document to the storage device 30. The transfer authentication information is personal information that is not desired to be made public. Therefore, some users may feel uneasy to input personal information to the information processing device 10 that is installed in a store that is open to the general public. However, in the case of the information processing system 100 according to an exemplary embodiment, personal information such as transfer authentication information may be input using the portable device 40. Therefore, compared to the case where personal information is input to the information processing device 10, user's uneasiness about leakage of personal information may be reduced.

Furthermore, in an exemplary embodiment, an example in which the external device 20 performs the post-process has been described. However, the information processing device 10 may perform the post-process subsequently to the pre-process. In this case, when the information processing device 10 that provides a service for a fee confirms payment for the fee or when the information processing device 10 that provides a service for free of charge finishes the pre-process, the information processing device 10 may transmit identification information to the portable device 40. By writing the URL of the information processing device 10 in the identification information, an instruction for the post-process is issued from the portable device 40 to the information processing device 10.

Furthermore, the external device 20 according to an exemplary embodiment may employ cloud computing.

Exemplary embodiments of this disclosure have been described above. However, this disclosure is not limited to the exemplary embodiments described above. Various changes or improvements may be made to exemplary embodiments of this disclosure without departing from the scope of this disclosure. Modes to which the changes or improvements may be made are also within the technical scope of this disclosure. For example, the order of processing steps may be changed without departing from the scope of this disclosure.

Furthermore, in a foregoing exemplary embodiment, for example, a case where a process illustrated in each of FIGS. 3, 5, and 6 is implemented by software has been explained. However, the process equivalent to the flowchart illustrated in each of FIGS. 3, 5, and 6 may be implemented in, for example, an application specific integrated circuit (ASIC) or may be processed by hardware. In this case, compared to the case where each process is implemented by software, the process may be performed more quickly.

Furthermore, in an exemplary embodiment described above, a case where the information processing program is installed in the ROM 52 has been explained. However, this disclosure is not limited to this. The information processing program according to an exemplary embodiment of this disclosure may be stored in a computer-readable recording medium and provided. For example, an information processing program according to an exemplary embodiment of this disclosure may be recorded in an optical disc such as a compact disc (CD)-ROM or a digital versatile disc (DVD)-ROM. Furthermore, an information processing program according to an exemplary embodiment of this disclosure may be recorded in a semiconductor memory such as a USB memory or a flash memory and provided. Furthermore, each device included in the information processing system 100 may acquire a program via the communication line 2.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a generation unit that generates data corresponding to a process specified by a user; and
a providing unit that provides, after generation of the data, identification information to be used by the user to issue an instruction for a post-process for the data generated by the generation unit.

2. The information processing device according to claim 1,
wherein the providing unit provides the identification information to an electronic device specified by the user.

3. The information processing device according to claim 2,
wherein an electronic device that the user owns is specified as the electronic device.

4. The information processing device according to claim 3,
wherein the electronic device is an electronic device that is carried by the user.

5. The information processing device according to claim 2,
wherein an information processing device for which the user has issued an instruction to start the process is specified as the electronic device.

6. The information processing device according to claim 5,
wherein the providing unit provides the identification information in a format that is able to be read by an optical sensor.

7. The information processing device according to claim 1, further comprising:
a transmission unit that transmits the data to an external device that is to perform a post-process for the data,
wherein the identification information is used to issue an instruction for the post-process for the data to the external device to which the data has been transmitted by the transmission unit.

8. The information processing device according to claim 7,
wherein the providing unit provides the identification information in the case where the data is transmitted by the transmission unit to the external device.

9. The information processing device according to claim 1,
wherein the generation unit generates the data for a fee, and
wherein the providing unit provides the identification information once the fee for generation of the data has been paid.

10. The information processing device according to claim 1,
wherein the process is a scan process for optically reading contents of an original.

11. An information processing device comprising:
generation means for generating data corresponding to a process specified by a user; and
providing means for providing, after generation of the data, identification information to be used by the user to issue an instruction for a post-process for the data generated by the generation means.

12. A non-transitory computer readable medium storing a program causing a computer to execute a process for information processing, the process comprising:
generating data corresponding to a process specified by a user; and
providing, after generation of the data, identification information to be used by the user to issue an instruction for a post-process for the generated data.
